(19) United States
(12) Patent Application Publication
(10) Pub. No.: US 2003/0206496 A1
(43) Pub. Date: Nov. 6, 2003

(54) Timer and alarm apparatus for physical exercises

(76) Inventor: Anthony Joseph Neilly, Holland, MI (US)

Correspondence Address: BROWDY AND NEIMARK, P.L.L.C., 624 NINTH STREET, NW, SUITE 300, WASHINGTON, DC, 20001-5303, US

(21) Appl. No.: 10/136,422

(22) Filed: May 2, 2002

(51) Int. Cl. G04F 8/00; G04F 10/00

(52) U.S. Cl. 368/108

(57) ABSTRACT

A timer and alarm apparatus is disclosed for use in physical exercises to signal the user of the time to resume exercising. The timer and alarm apparatus starts counting time when pressed by the user, and emits an alarm signal to inform the user when a predetermined length of time has been reached.

### FIELD OF THE INVENTION

The present invention relates to a timer and alarm apparatus and, more specifically, to a timer and alarm apparatus specifically designed for use in physical exercises to inform or signal the user when to resume exercising after a given rest period.

### BACKGROUND OF THE INVENTION

Conventional timers and alarm apparatus, for example, alarm clocks include electronic type, mechanical type, as well as electronic and mechanical combination type. These timers and alarm apparatus provides a setting function for enabling the user to set the desired alarm time. The setting of an alarm time of an alarm clock is based on the time unit of “minute” but not “second”. When setting an alarm time, on a timer, the user needs to rotate the indices (mechanical type), or to press the setting control button several times (electronic type). This complicated alarm time setting procedure may bother some users.

Furthermore, there are timers designed to count time based on the time unit of “second” or “1/1000 second”, for example, a stopwatch. However, the time setting procedures is of these timers also complicated, and involves pressing a series of buttons.

“Timer and Alarm Apparatus” of U.S. Pat. No. 4,361,408 is designed for use in medicine containers or the like. The apparatus comprises a timer interval measuring means, interval setting means, display means, alarm means, keys, and indicator means. According to this design, the user needs to set the desired time interval, and to know the current setting and using status through the display means.

### SUMMARY OF THE INVENTION

The primary object of the present invention is to provide a timer and alarm apparatus, which is specifically designed for use in physical exercises.

It is another object of the present invention to provide a timer and alarm apparatus, which is convenient to use without setting and resetting procedures.

It is another object of the present invention to provide a timer and alarm apparatus, which is simple and inexpensive to manufacture.

To achieve these objects of the present invention, the timer and alarm apparatus for use in physical exercises is comprised of a casing, and a timing and alarm circuit mounted inside the casing. The timing and alarm circuit comprises a multi-function timing IC that provides the functions of counting time and processing signal input and output, a power supply unit electrically connected to the multi-function timing IC to provide the necessary working voltage, and an alarm unit mounted inside the casing and electrically connected to the multi-function timing IC and controlled by the multi-function timing IC to output an alarm signal. The timer and alarm apparatus further comprises a button disposed outside the casing and connected to the inside of the casing. The button has one end connected to the power supply unit and an opposite end connected to the multi-function timing IC.

### BRIEF DESCRIPTION OF THE DRAWINGS

FIG. 1 is a schematic drawing showing the outer appearance of a timer and alarm apparatus according to the present invention.

FIG. 2 is a circuit diagram of the timer and alarm apparatus according to the present invention.

FIG. 3 is a circuit diagram of an alternate form of the present invention, showing a vibrator used for the alarm unit.

FIG. 4 is a circuit diagram of another alternate form of the present invention, showing a light emitting diode used for the alarm unit.

FIG. 5 is a circuit diagram of still another alternate form of the present invention, showing a voice IC used for the alarm unit.

### DETAILED DESCRIPTION OF THE INVENTION

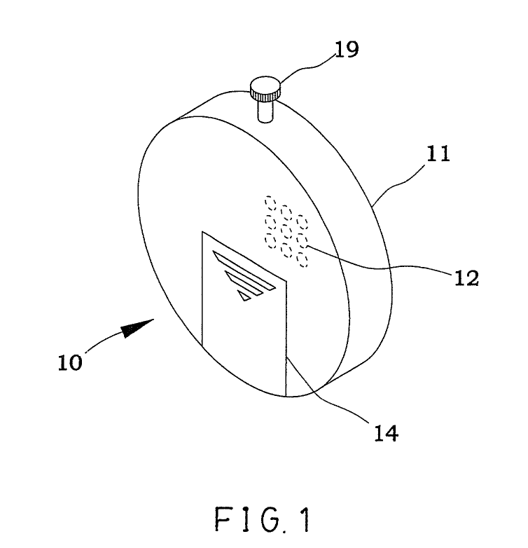

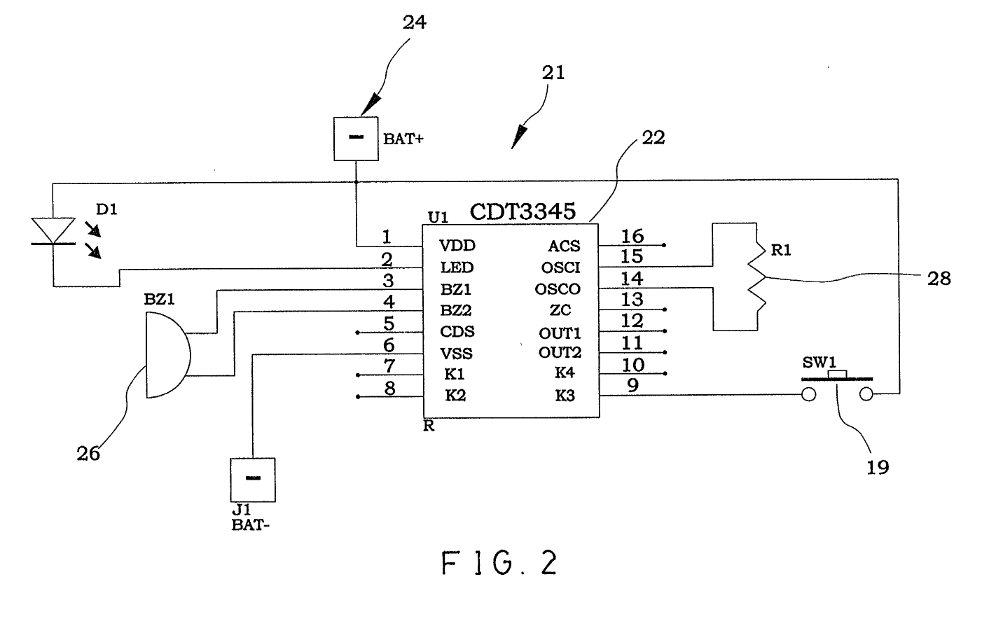

Referring to FIGS. 1 and 2, a timer and alarm apparatus 10 is disclosed for use in physical exercises, comprised of a casing 11, a timing and alarm circuit 21, and a button 19.

The casing 11 has holes 12 at predetermined locations, and a battery chamber 14.

The timing and alarm circuit 21 is mounted inside the casing 11, comprised of a multi-function timing IC 22, a power supply unit 24, an alarm unit 26, and a resistor 28.

The multi-function timing IC 22, such as a model No. CDT3345 complex function IC, provides the functions of counting time and processing signal input and output.

The power supply unit 24, for example, a battery set, is installed in the battery chamber 14 and electrically connected to the multi-function timing IC 22 to provide the necessary working voltage.

The alarm unit 26, for example, a speaker, is mounted inside the casing 11 corresponding in location to the holes 12 and adapted to output audible sound waves toward the outside of the casing 11 through the holes 12.

The resistor 28 has two ends respectively connected to the two frequency regulating ends of the multi-function timing IC 22, such that the multi-function timing IC 22 produces a relative time pulse subject to the resistance value of the resistor 28.

The button 19, for example, a push button, is disposed outside the casing 11 and connected to the inside of the casing 11. The button 19 has one end connected to the power supply unit 24 and the other end connected to the multi-function timing IC 22.

When in use, the user needs only to press the button 19 once. When user presses button 19 the first time, the buzzer will generate an alarm sound such as “beep” and the timing IC 22 is simultaneously activated and starts counting time. When a predetermined length of time is reached, for example, 30 seconds, the timing IC 22 immediately drives the alarm unit (speaker) 26 to output an alarm sound for 5 seconds.

When exercising different actions in the gym, for example weight-training, the exerciser usually takes a rest for about, for example, 30 seconds after each set or repetition. For example, 10 repetitions (1^{st} set) of one action or exercise, then nest for 30 secnods, then repeat the repitition of 10 again. The exerciser will perform four sets of 10 repetitions with a 30 second rest between each set. ie. 1set (10 repetitions) 30 sec. rest 1set etc. The invention enables the user to conveniently manage and monitor the rest time between sets of the (said) excercise. When the user presses button (19) again, the timer and alarm apparatus 10 will generate an alarm after 30 seconds, signaling the user to start the next repetition again.

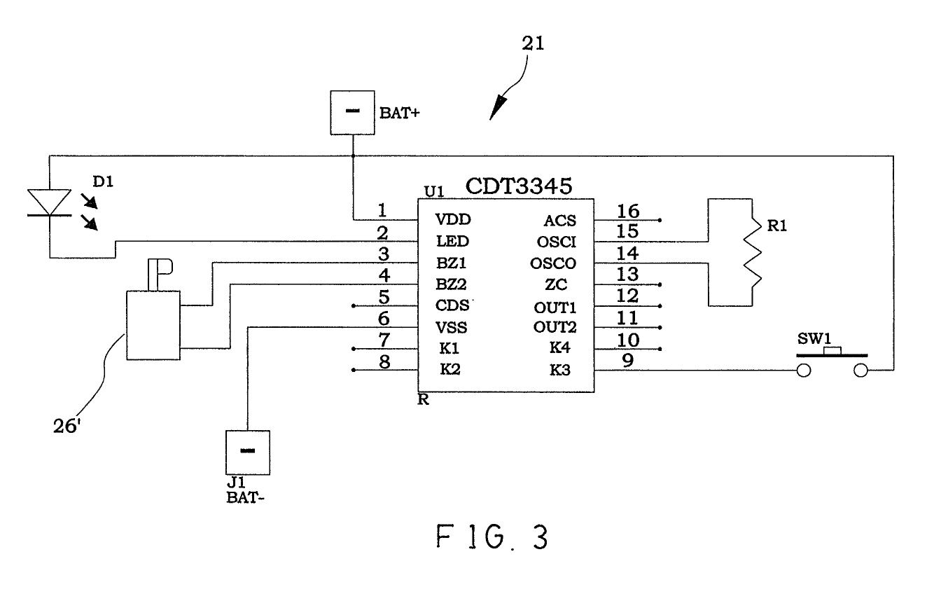

FIG. 3 shows an alternate form of the present invention. According to this alternate form, the alarm unit, referenced by 26′ is a vibrator (or vibration motor) that provides vibrating waves to warn the user.

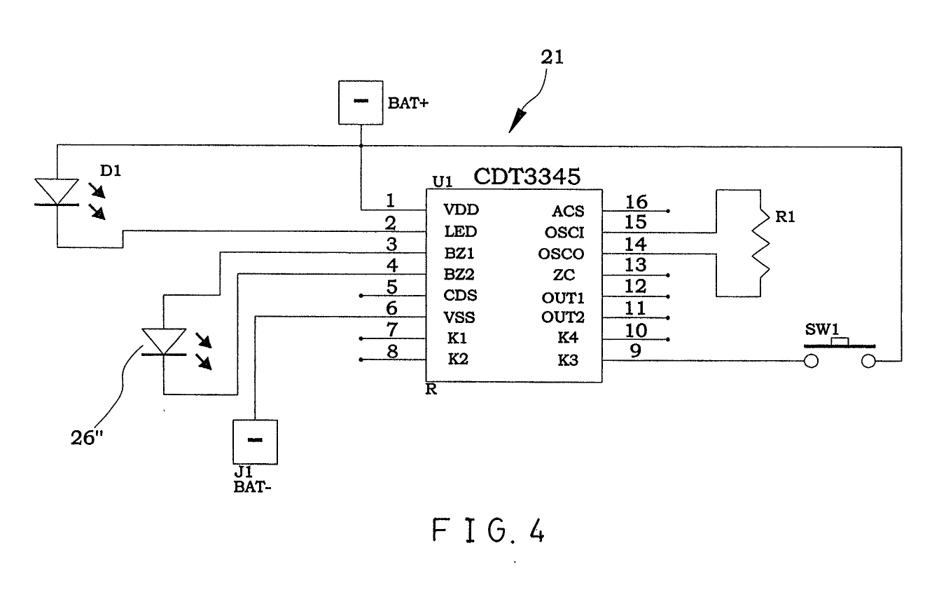

FIG. 4 shows another alternate form of the present invention. According to this alternate form, the alarm unit, referenced by 26″, is a light emitting diode, which gives a visual signal to warn the user when triggered.

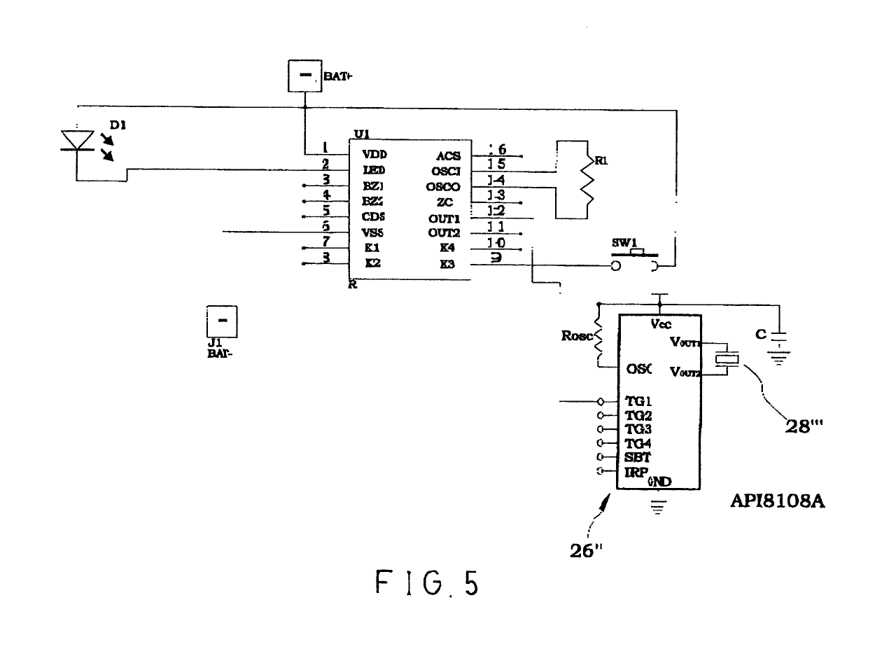

FIG. 5 shows still another alternate form of the present invention. According to this alternate form, the alarm unit, referenced by 26′″, is a voice IC, which, when triggered, outputs a voice message through a speaker, referenced by 28′″ to warn the user.

Furthermore, the alarm unit of the present invention can be a combination of a speaker, a vibrator, and a light emitting diode, and adapted to warn the user with an audio alarm, a vibration signal, and a visual alarm at the same time when triggered.

As indicated above, the invention achieves the following advantages:

1. No setting needed. When in use, the user needs only to press the button 19. Pressing the button 19 once, the timer and alarm apparatus gives an alarm signal at a predetermined time, i.e., one-press action results in one alarm. The operation of the timer and alarm apparatus is so simple without setting.

2. Simple structure and low manufacturing cost. The timer and alarm apparatus is specifically designed for physical exercises. The functions of the timer and alarm apparatus satisfy user's demands. Because of simple structure, the manufacturing cost of the timer and alarm apparatus is low.

What is claimed is:

1. A timer and alarm apparatus for use in physical exercises comprising:
a casing;
a timing and alarm circuit mounted inside said casing, said timing and alarm circuit further comprising:
a multi-function timing IC that provides the functions of counting time and processing signal input and output;
a power supply unit electrically connected to said multi-function timing IC to provide the necessary working voltage;
an alarm unit mounted inside said casing and electrically connected to said multi-function timing IC and controlled by said multi-function timing IC to output an alarm signal;
a button disposed outside said casing and connected to the inside of said casing, said button having one end connected to said power supply unit and an opposite end connected to said multi-function timing IC.

2. The timer and alarm apparatus as claimed in claim 1, wherein said alarm unit is a speaker controlled by said multi-function timing IC to output an audio alarm signal; said casing has holes corresponding in location to said speaker.

3. The timer and alarm apparatus as claimed in claim 1, wherein said alarm unit is a vibrator.

4. The timer and alarm apparatus as claimed in claim 1, wherein said alarm unit is a light emitting body.

5. The timer and alarm apparatus as claimed in claim 4, wherein said alarm unit is a light emitting diode.

6. The timer and alarm apparatus as claimed in claim 1, wherein said power supply unit is a battery set.

7. The timer and alarm apparatus as claimed in claim 6, wherein said casing comprises a battery chamber adapted to hold said battery set.

8. The timer and alarm apparatus as claimed in claim 1, wherein said button is a push button.

9. The timer and alarm apparatus as claimed in claim 1, wherein said timing IC is set to count a predetermined length of time within 10˜200 seconds.
